(19) United States
(12) Patent Application Publication
(10) Pub. No.: US 2006/0283876 A1
(43) Pub. Date: Dec. 21, 2006

(54) Automatic medication dispensing alarm system

(76) Inventors: Carl Herbert Mocnik, San Jose, CA (US); Thao Tran, San Jose, CA (US)

Correspondence Address: Carl Mocnik, 1585 Timber Creek Drive, San Jose, CA, 95131, US

(21) Appl. No.: 11/145,621

(22) Filed: Jun. 6, 2005

(51) Int. Cl. B65G 59/00

(52) U.S. Cl. 221/300

(57) ABSTRACT

An Automatic Medication Dispensing Alarm System is disclosed which, when integrated into or with a dispenser or container of pills, tablets or similar pharmaceutical preparations, periodically and automatically reminds a patient/consumer to administer the preparation as part of a prescribed periodic tablet regimen.

### FIELD OF THE INVENTION

This invention relates to an Automatic Medication Dispensing Alarm System.

### BACKGROUND

Medicaments and other pharmaceutical preparations are often prescribed for patients on a time related or scheduled dispensing basis. Examples of tablets or pills that are prescribed in a set periodic regimen include tablets or pills adapted for oral ingestion that are used for birth control, for regulating blood pressure, for regulating blood lipids, as antibiotics and for treating a variety of other ailments such as diabetes. Such extended time periodic regimens are particularly adaptable to preventative medicine (e.g., regulating blood pressure or birth control) or for treatment of chronic ailments which all require a relatively long course of therapy.

The amount of drug provided in a solid form pharmaceutical preparation such as a tablet or pill is inherently controlled so that each tablet contains a fixed amount of dosage so that there is little or no confusion as to the amount which should be taken. However, variability in pharmaceutical administering is often, if not invariably, attributable to patient uncertainty, forgetfulness and/or confusion as to whether or not a tablet has been taken at the prescribed rate and time. This problem can be compounded when the dosage is to be repeated a number of times daily or when multiple medicaments are prescribed or when medicaments are to be taken over a long course of therapy which may extend from weeks to years. This problem may be applicable to most every type of patient including the elderly, the chronically ill (who may be in a weakened state), and the active person engaged in a long term course of treatment such as contraception or hormone replacement therapy.

As a result of problems of confusion, uncertainty or forgetfulness a patient may in reality take more or less than the prescribed rate of dosage that is indicated, thereby, inadvertently altering the prescribed course of treatment. To assure the maximum effectiveness of the prescribed medication it is desirable to provide a dispenser with a means that will aid the patient in adhering to the prescribed time schedule for dosing, whether that be daily doses, multiple daily doses or less frequent doses. Tablet dispensers and devices for dispensing solid form pharmaceutical preparations such as tablets or pills over a time related sequence are known. An example of such a tablet dispenser is disclosed in U.S. Pat. No. 5,551,597 which provides a dispenser which allows a patient to take a tablet on a prescribed basis, e.g. a daily basis, by providing an indicator that denotes the days of the week. The disclosure of this patent is hereby incorporated herein by reference.

The limitation of such dispensers is that the onus is on the patient to initiate the inspection and dispensing of the medication, whereby the patient must firstly remember to initiate an inspection of the dispenser, secondly the patient must visually ascertain when the next dosage is due, and thirdly the patient must then mentally compare this time or day with the current time or day to ascertain whether the medication is currently due for administering.

Thus, the inherent problem with existing dispensers of tablets supporting a prescribed periodic tablet regimen is that the patient may simply forget to inspect the dispenser to ascertain whether and when administering of the medication is due and/or, through confusion or uncertainty, may incorrectly interpret when administering of the medication is due.

To address these issues, U.S. Pat. No. 5,551,597 discloses a tablet dispenser component system having as a first component a rotatable substantially circular unidirectional knob having indicators of periodicity thereon. The rotatable knob is encircled with a notched skirt comprising a plurality of notches spaced substantially equally apart. A substantially flat support with a single tablet dispensing aperture and a rising wall portion protruding therefrom forms an interior cup portion. A center axis means is engaged and fixed onto the flat support. A first engagement means is provided whereby the rotatable knob is rotatably joined to the flat support. A second engagement means is provided comprising unidirectional ratchet means to form a functional system with the rotatable knob for unidirectionally rotating the rotatable knob in a circular fashion about the center axis means. The rotatable knob and either the flat support or central axis means have unidirectional ratchet means comprising a plurality of ratchet stops corresponding to a single space or notch on the notched skirt.

### SUMMARY

In one aspect, a medication dispensing alarm system includes a main timer circuit, a switch coupled to the main timer circuit, a pulse shaping circuit coupled to the main timer circuit; and an alarm device coupled to the pulse shaping circuit.

In another aspect, a medication dispensing alarm system includes a main timer circuit, a switch coupled to the main timer circuit, a secondary timer circuit coupled to the main timer circuit, a first pulse shaping circuit coupled to the main and the secondary timer circuit; a visual alarm device coupled to the first pulse shaping circuit, a second pulse shaping circuit coupled to the secondary timer circuit; and an audible emission device coupled to the second pulse shaping circuit.

In yet another aspect, a main timer is activated and initiated when a tablet or pill is dispensed, whereby a switch detects the opening of the lid of the pill container or the rotation of a rotational pill dispenser. This timer, upon the conclusion of a period of time corresponding to the required frequency of administering of the tablets, such as 24 hours in the case of the contraceptive pill, emits a visual alarm such as from a Light Emitting Diode (LED), pro-actively reminding the patient to dispense the tablet. Should the patient not dispense the pill within a few minutes of the activation of the visual indicator, an audible indicator will then begin to emit sound. These alarms alert the patient to administer the prescribed medication, thereby minimizing the likelihood of the patient altering the prescribed course of treatment.

The main timer is supplied power via a switch contact. When the switch contact is closed, the main timer circuit is energized and initialized. At the conclusion of the prescribed period, such as 24 hours in the case of the contraceptive pill, the output of the main timer provides power to a visual indicator device such as a Light Emitting Diode (LED) and an audible indicator device such as a piezoelectric sound transducer. These indicators alert the patient to dispense the prescribed medication.

When the patient then opens the lid of the pill container, or rotates the dispenser feed mechanism, the switch is automatically opened and then closed, serving to de-energize and remove power from the circuit, extinguishing the alarms, and then reinitializing the circuit. This action effects the automatic medication dosage reminder mechanism.

Another aspect of the system incorporates two pulse shaping circuits which are driven from the output of the main timer, with one pulse shaping circuit to drive the visual device (e.g., the LED) and the second pulse shaping circuit to drive the audible device. The first pulse shaping circuit would modify the output of the visual device to intermittent flashes of light, and the second pulse shaping circuit would modify the audible alarm to intermittent beeping.

Advantages of the invention may include one or more of the following. The system, when integrated into or with a dispenser or container of pills, tablets or similar pharmaceutical preparations, periodically and automatically reminds a patient/consumer to administer the preparation as part of a prescribed periodic tablet regimen. The system provides a pro-active alarm or reminder based upon an electronic timer, whereby the timer is automatically initialized upon the dispensing of the pill, and at the conclusion of the prescribed time, such as 24 hours in the case of the contraceptive pill, an audible and visible alarm proactively alerts the patient to administer the next scheduled dose. The design minimizes the likelihood of the patient altering the prescribed course of treatment by providing an automatic and relatively foolproof reminder/alarm at each instance when the prescribed pharmaceutical preparation is due for administering, assuring compliance with the prescribed periodic tablet regimen and avoiding inadvertent mistakes in administering the pharmaceutical preparation. The system can be incorporated into a dispenser, such that together the combined invention and dispenser can provide a prescribed regimen of pills in a consistent manner with a high degree of confidence while providing an “any time” start feature.

One exemplary application can be a contraceptive pill dispenser due to the inherent advantage to the many patients currently utilizing the contraceptive pill. The advantages of the system to such patients of the contraceptive pill are overwhelming, considering that the majority of instances of failure of the contraceptive pill are attributed to the forgetfulness of the patient to administer the medicament. However, the patients prescribed the contraceptive pill represent only one of many groups that will realize the advantages of the invention, for the invention also benefits patients prescribed tablets or pills for regulating blood pressure, for regulating blood lipids, for antibiotics, for treating other ailments such as diabetes and all other chronic ailments which require a relatively long course of therapy of a set periodic medicament regimen. This invention will minimize the risk of unwanted pregnancy for those patients prescribed a course of the contraceptive pill, and will minimize the possibility of death or other significant medical complication for those patients prescribed a course of medicaments for regulating blood pressure, for regulating blood lipids, antibiotics and treatments for a variety of other ailments such as diabetes and other chronic ailments.

### BRIEF DESCRIPTION OF THE DRAWINGS

FIG. 1 illustrates a view of a first embodiment of a tablet dispenser.

FIG. 2 shows an exemplary physical arrangement of the electronics assembly in FIG. 1.

FIG. 3 shows an exemplary electronic schematic diagram for the electronics assembly, while FIG. 4 shows the associated timing diagram of the circuit of FIG. 3.

FIG. 5, FIG. 6 and FIG. 7 show exemplary physical arrangements of the automatic medication dispensing alarm system.

FIG. 8 shows a cross-sectional view a second embodiment integrated into the cap of a generic pill dispenser bottle.

### DESCRIPTION

Reference will now be made in detail to preferred embodiments of the invention. Examples of two preferred embodiments are illustrated in the accompanying figures, and one generic embodiment is textually described, and provided in detail below with reference to such figures and the numbers provided therein.

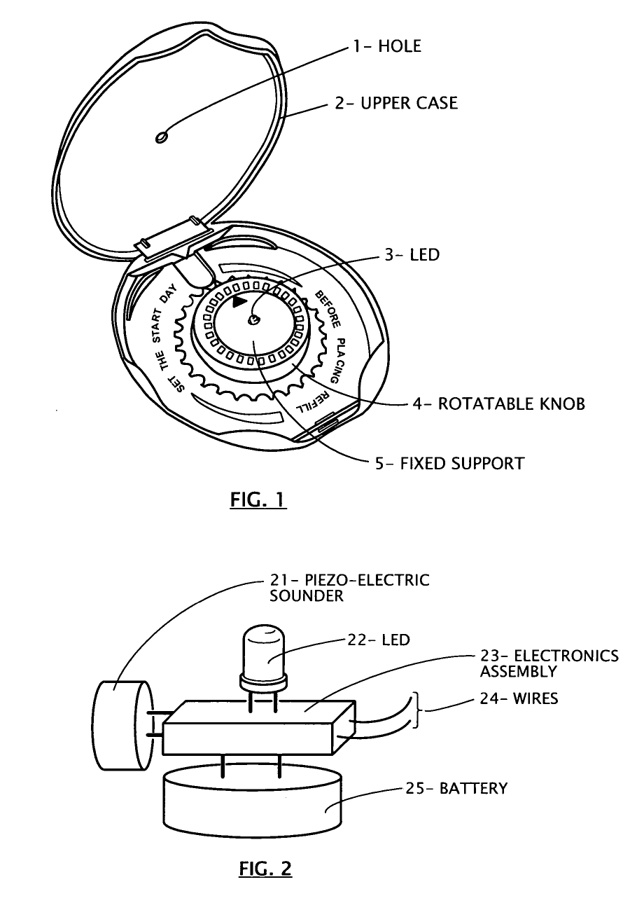

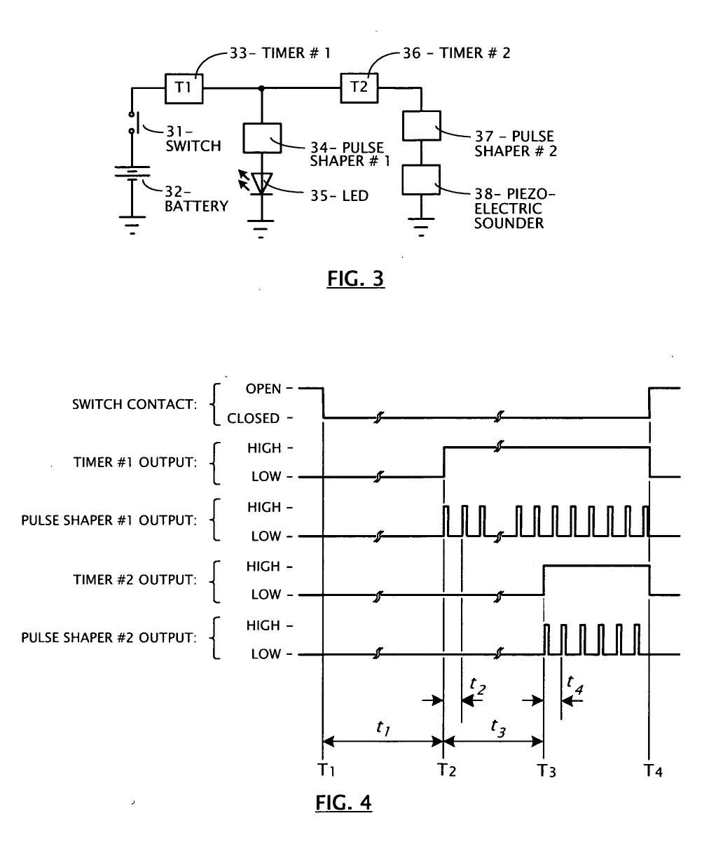

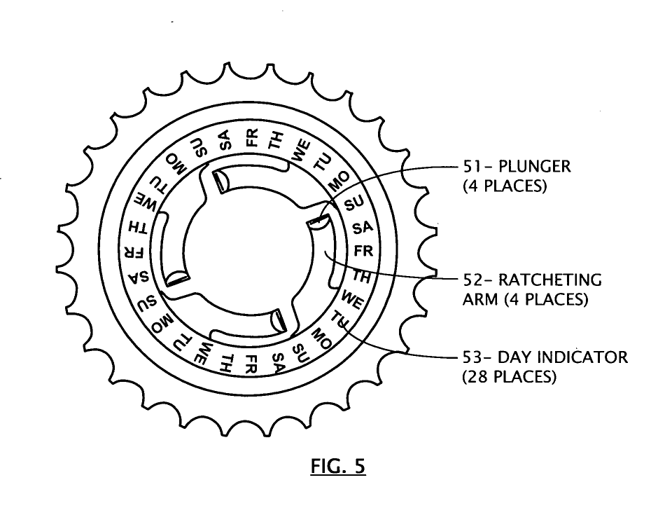

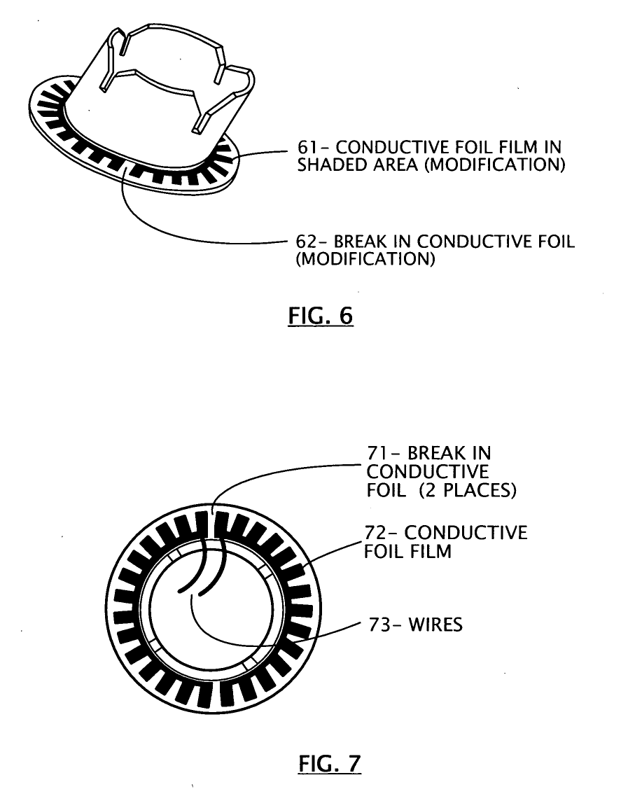

FIG. 1 illustrates a view of a first embodiment of a tablet dispenser which is further detailed in FIG. 5, FIG. 6 and FIG. 7. The physical arrangement of the electronics assembly of the invention is shown in FIG. 2. FIG. 3 shows the electronic schematic diagram for the electronics assembly of the invention, while FIG. 4 shows the associated timing diagram of the circuit.

Turning now to FIG. 1, a contraceptive pill dispenser is shown enhanced with an alarm system. The pill dispenser can be the dispenser disclosed in U.S. Pat. No. 5,551,597, the content of which is incorporated-by-reference. As discussed in U.S. Pat. No. 5,551,597, the tablet dispenser component system having as a first component a rotatable substantially circular unidirectional knob having indicators of periodicity thereon. The rotatable knob is encircled with a notched skirt comprising a plurality of notches spaced substantially equally apart. A substantially flat support with a single tablet dispensing aperture and a rising wall portion protruding therefrom forms an interior cup portion. A center axis means is engaged and fixed onto the flat support. A first engagement means is provided whereby the rotatable knob is rotatably joined to the flat support. A second engagement means is provided comprising unidirectional ratchet means to form a functional system with the rotatable knob for unidirectionally rotating the rotatable knob in a circular fashion about the center axis means. The rotatable knob and either the flat support or central axis means have unidirectional ratchet means comprising a plurality of ratchet stops corresponding to a single space or notch on the notched skirt. The exemplary pill dispenser of U.S. Pat. No. 5,551,597 lacks a dispensing alarm.

Referring to FIG. 1, the dispensing alarm system includes a LED 3 which is mounted in a fixed support 5 of the dispenser. A corresponding hole 1 is drilled in an upper case 2 of the dispenser such that the upper portion of the LED protrudes and is easily observed by the patient. Access to the inner void within the fixed support is implemented by an access cover placed directly beneath the fixed support. This void then houses the electronics assembly. The switch is created by modifying the rotatable knob 4 and the fixed support structure 5 of the dispenser, such that the action of rotating the rotatable knob from one position to the next position opens and then closes the switch. The modification to the rotatable knob is detailed in FIG. 5 and the modification to the fixed support structure is detailed in FIG. 6 and FIG. 7.

Referring to FIG. 2, an exemplary physical arrangement of the components for one embodiment is shown. In FIG. 2, an electronics assembly 23 is connected to an LED 22, a replaceable battery 25, a piezoelectric sounder 21, and wires 24 leading to the switch contacts (not shown).

Turning now to FIG. 3, a timing circuit is shown. A main timer 33 is supplied power from a battery 32 via a switch contact 31, such that when the switch contact is closed the main timer circuit is energized and initialized. The main timer provides power to the subsequent circuit after the conclusion of the countdown period which corresponds to the prescribed medication period, such as 24 hours in the case of the contraceptive pill. At the conclusion of the prescribed period, the output of the main timer provides power to a visual device such as a Light Emitting Diode (LED) 35 via a pulse shaping circuit 34, and to a second timer 36. At the conclusion of the countdown of the second timer (several minutes in the case of the 24-hour contraceptive pill) power is then applied to the audible alarm (such as a piezoelectric sound transducer) 38 via the second pulse shaping circuit 37. These visual and audible alarms alert the patient to dispense the prescribed medication. When the switch contact is opened, the entire circuit is de-energized, extinguishing the alarms. When the switch contact is then closed the circuit is re-initiated and the process described above repeats. Thus, in the case of a contraceptive pill dispenser, the visual alarm activates upon conclusion of 24 hours, and the audible alarm emits sound within an hour following the initiation of the visual alarm.

Referring to the circuit timing diagram shown in FIG. 4, atypical timing arrangement in a contraceptive pill dispenser embodiment is shown. In FIG. 4:
t₁=24 hours This is the period of the first countdown timer and represents the length of time between required dosages of the contraceptive medication.
t₂=1 second This is the period between flashes of the LED.
t₃=2 hours This is the period of the second countdown timer, and corresponds to the length of time between when the LEDs start to flash and the piezoelectric sounder starts to emit sound.
t₄=1 second This is the period between beeps of the sound emitting device (e.g., piezoelectric transducer).
T₁ This point in time corresponds to the instance when the switch is transitioned from an open state to a closed state.
T₂ This point in time corresponds to the instance when the main timer output is enabled.
T₃ This point in time corresponds to the instance when the secondary timer the output (which drives the audible alarm device) is enabled.
T₄ This point in time corresponds to the instance when the switch is transitioned from a closed state to an open state.

Turning now to the rotatable knob in FIG. 5, the rotatable knob contains four ratcheting arms 52. The plungers 51 at the end of each ratcheting arm engage the underside of the fixed support structure, as shown in more detail in FIG. 6, enabling the ratcheting action which restricts the rotation of the rotating pill selector mechanism to only the clockwise direction, and preventing the rotating pill selector mechanism from halting in any position other than in a position corresponding to the day indicators 53. The surface of the rotatable knob is modified by bonding a conductive foil or film to the exterior surface, such that each plunger 51 is electrically connected to all other plungers.

FIG. 6 shows an exemplary fixed support structure for the knob of FIG. 5. A conductive film or a layer of conductive foil 61 is bonded into the recessed grooves that receive the plungers of the ratcheting arms, in a manner such that the conductive foil in each of the recessed grooves is electrically connected to each of its neighboring recessed grooves. Two breaks 62 in the electrical path of the conductive foil are introduced in the electrical foil, spaced 180 degrees apart, such that two separate and non-electrically connected geographical arcs are created from the conductive foil. This is further illustrated in FIG. 7.

FIG. 7 shows a fixed support structure where two conductive films 72 are separated by two breaks 71 in the foil. A wire 73 is then bonded to each of the two separate conductive films. As the rotatable knob is rotated, the ratcheting arms will first make electrical contact and then break electrical contact with the two conductive foils, allowing the two wires to have a short circuit and then an open circuit, respectively, appear across their ends, successfully implementing the required switch.

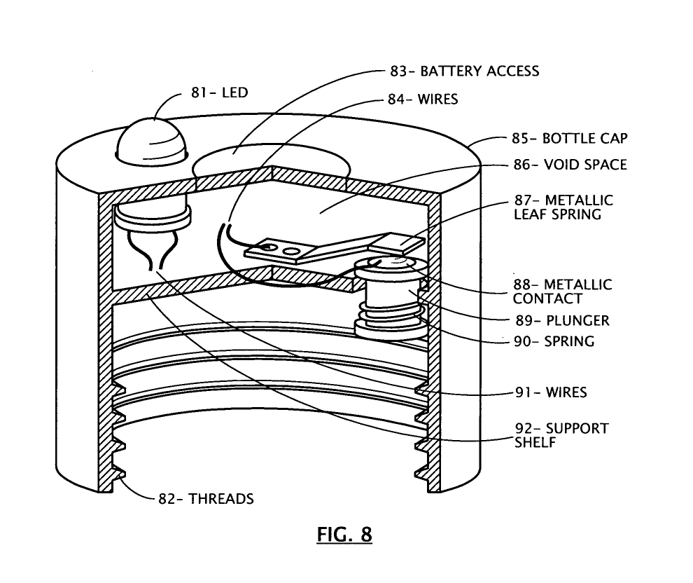

Referring now to FIG. 8, a second embodiment of the alarm system is shown. FIG. 8 shows a cross-sectional view of the invention integrated into the cap of a generic pill dispenser bottle. The embodiment of FIG. 8 is adapted to a cap 85 of a regular pill container. Threads 82 in the cap fasten the cap to the bottle. The cap is modified by creating a void 86 within it by the addition of a support shelf 92 which is utilized for mounting the electronics. Access into this void space, such as for insertion and replacement of the battery (not shown), is accomplished via an access cover 83 mechanically fastened into the cap. A LED 81 is mounted directly into the cap. Two wires 91 from the LED lead to the electronics assembly (not shown) mounted within the void space 86. The switch is implemented by a mechanical plunger 89 that is depressed when the cap is fully screwed onto the pill container. A spring 90 ensures that the plunger is extended when the cap is removed from its associated container. When the cap has been fully screwed onto the pill container the lip of the container will depress the plunger 89 causing the metallic contact 88 to make contact with a metallic spring leaf 87. Two wires 84 are bonded to the metallic leaf spring and the metallic contact, from which the electrical switching action is detected. Thus, when the cap is removed from the bottle the switch is opened and the electronics assembly is automatically deactivated; and when the cap is replaced onto the bottle the switch is closed, automatically re-powering and reinitializing the electronic circuit.

Thus there has been provided an Automatic Medication Dispensing Alarm System which, when integrated into or with a tablet dispenser or tablet container, periodically and automatically reminds a patient to administer pills, tablets or similar pharmaceutical preparations according to a time related regimen, and the possibility of mis-administering such pharmaceutical preparations through forgetfulness, uncertainty and/or confusion is minimized.

The example of the incorporation of this invention into or with a contraceptive pill dispenser is described throughout this specification, due to the inherent advantage to the many patients currently utilizing the contraceptive pill. The advantages of this invention to such patients of the contraceptive pill are both overwhelming and obvious, considering that the majority of instances of failure of the contraceptive pill are attributed to the forgetfulness of the patient to administer the medicament. However, the patients prescribed the contraceptive pill represent only one of many groups that will realise the advantages of the invention, for the invention also benefits patients prescribed tablets or pills as part of a set periodic regimen for regulating blood pressure, for regulating blood lipids, for antibiotics, for treating other ailments such as diabetes and all other chronic ailments which require a relatively long course of therapy of a set periodic medicament regimen.

The scope of the present invention is not limited by the description, examples and suggested uses herein and modifications can be made without departing from the intended scope and spirit of the invention. For example, other output devices and indicators may be added or incorporated into or onto the invention, including a low battery warning indicator, and communications devices can be incorporated for transmitting the remote alarm to remote monitoring equipment.

The present invention may also be used to assist in the dispensing of vitamins, minerals or other nutrients.

As illustrated above, application of the present invention for medical and pharmaceutical uses can be accomplished by any clinical, medical, pharmaceutical and electronics engineering methods and techniques as are presently and prospectively known to those skilled in the art. Thus it is intended that the present invention cover the modifications and variations of this invention provided that they come within the scope of the appended claims and their equivalents.

What is claimed is:

1. A medication dispensing alarm system, comprising:
a main timer circuit,
a switch coupled to the main timer circuit,
a secondary timer circuit coupled to the main timer circuit,
a first pulse shaping circuit coupled to the main and the secondary timer circuit;
a visual alarm device coupled to the first pulse shaping circuit,
a second pulse shaping circuit coupled to the secondary timer circuit, and
an audible emission device coupled to the second pulse shaping circuit.

2. The alarm system of claim 1, wherein the switch, when closed following the dispensing of medication, provides power to automatically energize and initiate the main timer.

3. The alarm system of claim 2, wherein upon the conclusion of a prescribed period, the output of the main timer provides power to the visual alarm device via a pulse shaping circuit and to the secondary timer.

4. The alarm system of claim 3, wherein the secondary timer, after a second prescribed period, provides power to the audible alarm device via the second pulse shaping circuit.

5. The alarm system of claim 1, wherein the visual alarm device comprises a Light Emitting Diode (LED).

6. The alarm system of claim 1, wherein the audible emission device comprises a speaker.

7. The alarm system of claim 1, wherein the audible emission device comprises a piezoelectric sound transducer.

8. The alarm system of claim 1, wherein the prescribed period comprises 24 hours for a contraceptive birth-control pill.

9. The alarm system of claim 1, wherein the second prescribed period is less than the first prescribed period.

10. The alarm system of claim 1, comprising a bottle cap to house at least the LED.

11. A medication dispensing alarm system, comprising:
a main timer circuit,
a switch coupled to the main timer circuit,
a pulse shaping circuit coupled to the main timer circuit; and
an alarm device coupled to the pulse shaping circuit.

12. The alarm system of claim 11, comprising a secondary timer circuit coupled to the main timer circuit.

13. The alarm system of claim 12, comprising:
a second pulse shaping circuit coupled to the secondary timer circuit; and
an audible emission device coupled to the second pulse shaping circuit:

14. The alarm system of claim 11, wherein the alarm device comprises one of: visual alarm, audible alarm.

15. The alarm system of claim 11, wherein the switch, when closed following the dispensing of medication, provides power to energize and initiate the main timer.

16. The alarm system of claim 11, comprising a pill container lid housing at least the alarm device.

17. The alarm system of claim 16, wherein the switch is opened when a patient opens the lid of the pill container and the switch is closed when a patient replaces the lid of the pill container.

18. The alarm system of claim 16, wherein the switch is firstly opened and then closed when a patient rotates the dispenser feed mechanism.

19. The alarm system of claim 16, wherein the switch is opened and then closed to automatically de-energize and remove power from the circuit, extinguishing the alarms, and then reinitializing the circuit.

20. The alarm system of claim 11, wherein the alarm device comprises one of: a Light Emitting Diode (LED), a speaker, a piezoelectric sound transducer.
